(19) United States
(12) Patent Application Publication
(10) Pub. No.: US 2025/0042051 A1
(43) Pub. Date: Feb. 6, 2025

(54) 3D Pivoting Razor

(71) Applicant: Mahmoud Razzaghi, Laguna Niguel, CA (US)

(72) Inventor: Mahmoud Razzaghi, Laguna Niguel, CA (US)

(21) Appl. No.: 18/795,175

(22) Filed: Aug. 5, 2024

Related U.S. Application Data
(60) Provisional application No. 63/530,957, filed on Aug. 5, 2023.
(60) Provisional application No. 63/532,071, filed on Aug. 11, 2023.

(51) Int. Cl. B26B 21/40; B26B 21/06; B26B 21/22; B26B 21/52

(52) U.S. Cl. CPC B26B 21/4012; B26B 21/521; B26B 21/06; B26B 21/225

(57) ABSTRACT

The present invention replaces the pivoting in razors that use a multiplicity of a straight axis and two colinear supports, with a single resilient member. There is a razor cartridge comprised of a base and a razor blade frame with a plurality of razor blades. The base has a receiving end for temporary or permanent attachment to a handle. A resilient member having two ends is attached at one end to a middle location of the blade frame, and at the other end to the cartridge base. When the user holds the handle and places the blade frame on the shaving area, the blade frame rotates around three perpendicular axes through flexure or twisting of the resilient member to align with the shaving area. In another embodiment, the cartridge base or projections therefrom limit the rotation of the blade frame through contact with the blade frame or projections therefrom.

### CROSS-REFERENCE TO RELATED APPLICATIONS

This non provisional patent application has priority date of provisional patent applications 63/532,071 filed 11, August 2023 and 63/530,957 filed 05, August 2023.

This application is a substitute to the application Ser. No. 18/500,121 dated 02, November 2023 now abandoned.

### PRIOR ART

Devices for safe manual shaving of beard or body hair have a shaving head comprised of one or more razor blades installed in a blade frame assembled to a cartridge or directly attached to a handle.

For description, three axes are defined as x axis along the blades, y axis perpendicular to the blade frame face touching the shave area, and z axis along the handle.

The cartridge has a base. The frame is attached to the base via a first hinge along the frame or blade length (x-axis). The first hinge allows the frame to pivot or rotate around x axis and align with the shaving surface. A flexure mechanism provides smooth rotation of the frame, and a stop limits its rotation.

Most razors have just a single pivot for x axis. Some high end razors have two separate pivots for x and y axes, or x and z axes. The two axis system is more complex and costly. Due to this complexity, pivoting around y axis and flexure support for both x and y axes are designed into the razor handle while the blade cartridge merely provides pivoting around x axis.

In razors with reusable handle, the cartridge is attached to the handle through a latch mechanism by pushing the handle into the receiving end of the cartridge base and removed by pushing a button on the handle near the cartridge attachment area, or by pushing the cartridge away from the handle.

In one model of blade cartridge by Harry's company, the said first hinge is made of two integral flexing pieces of rubber at the two sides of the cartridge. A pair of stops at the lower edge of the blade frame interact with the base of the cartridge to limit the rotation of the blade frame.

In another model of these shaving devices by Gillette company, the blade frame has a pivot hinge along the x axis. The reusable handle additionally has a second hinge along the y-axis. The second hinge provides a second degree of freedom for the cartridge to rotate around the y axis and adapt to the shaving surface. The second hinge system includes a body with hinge, a bracket, a cantilever spring for y axis flexure and an axial spring supported pin for x axis flexure.

Schick company has introduced a similar two hinge mechanism in a disposable device. Implementation of the second hinge adds to the complexity and cost of the device.

Still, there is a third degree of freedom, or rotation of the blade cartridge around the z-axis that can provide further alignment of the blade frame with the shaving surface and uniform contact pressure on the skin. The addition of the third hinge for this feature to the present designs will further add to the complexity, size, and cost of the device.

Recently, the Japanese company Feather Safety Razor has introduced a razor named Feather F3, claiming “3D Pivoting Action” with a multiplicity of parts and assemblies. However, still the product provides pivoting only around x and z axes with an additional suspension pivoting mechanism around x axis. There is no pivoting mechanism or action around y axis.

### BACKGROUND OF THE INVENTION

This invention relates to razor cartridges and disposable razors in beard and body hair shaving devices.

In the present art of shaving devices, separate pivoting mechanisms are used for at most two axes. Each of these pivots have a straight axis with two end supports or bearings. Currently, there is no device with a mechanism for three axis alignment because implementation of an additional mechanism further adds to the complexity, size, and cost.

A low cost, simple and effective 3D pivoting mechanism is required for both high end and disposable razors.

Therefore, the object of this invention is to provide a razor with a single resilient or elastic member to allow pivoting of the razor blades around one, two, or three of the x, y, and z axes.

Another object of the invention is to make the technology of such a cartridge possible for low cost single use shaving devices.

The outcomes of the above objectives are:

To provide means in a shaving device to align the blade cartridge with the topography of the shaving area regardless of the user's hand alignment.

Distribute and limit the forces between the blade and skin arising from misalignment around any axis to reduce cuts and nicks on the skin.

### SUMMARY OF THE INVENTION

The present invention replaces the multiplicity of straight linear pivots in razors with a single deforming member.

There is a razor cartridge comprised of a base and a razor blade frame. The base has a receiving end for temporary or permanent attachment to a handle. The blade frame has upper and lower sides defining its length, left and right side sides defining its height, and an opening with a front face and back face. A plurality of razor blades is installed inside the blade frame with cutting edges along the frame length edges and aligned with the front face.

A resilient member having two ends is attached fixedly at one end to the back face or lower length edge of the blade frame or a projection therefrom, and at the other end to the cartridge base or a projection therefrom.

The blade frame can rotate around three axes along the blade frame length, perpendicular to the blade frame face, or along the blade frame height through flexure or twisting of the resilient member. The cartridge base or projections therefrom limit the rotation of the blade frame to a desired angle through contact with the blade frame or projections therefrom.

In another embodiment, upon further deformation, the resilient member provides the optimal force for shaving without the need for rigid stops. This embodiment prevents application of excessive shaving force by the user and the consequent scratching or cutting of the skin.

### BRIEF DESCRIPTION OF DRAWINGS

FIG. 1 shows the first preferred embodiment of the invention.

FIG. 2 shows the second preferred embodiment of the invention.

FIG. 3 shows the third preferred embodiment of the invention.

FIG. 4 shows the fourth preferred embodiment of the invention.

FIG. 5 shows the fifth preferred embodiment of the invention.

FIG. 6 shows the sixth preferred embodiment of the invention.

### DETAILED DESCRIPTION OF THE INVENTION

The present invention replaces the pivoting in razors that use a multiplicity of a straight axis and two supports, with a single deforming member.

The invention provides a single member in the cartridge or handle of a razor that allows three rotational degrees of freedom for the alignment of the razor blade frame or razor cutting edges with the surface to be shaved.

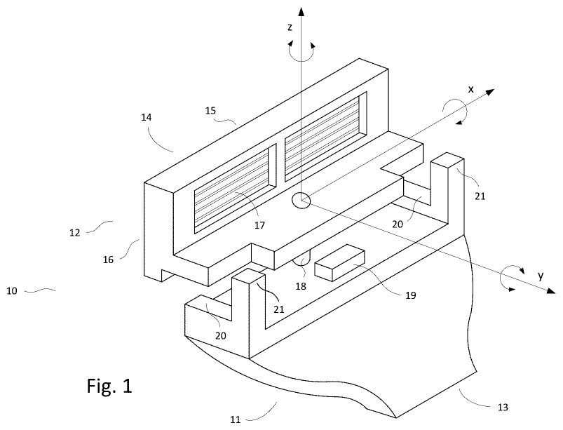

In the first preferred embodiment of the invention, FIG. 1, there is a razor cartridge 10 comprising base 11 and razor blade frame 12. Razor cartridge 10 can be attached to a handle at base end 13. Blade frame 12 has front face 14, length 15, and height 16. Length 15 defines upper and lower edges. Height 16 defines left and right edges. Blades 17 are attached inside frame 12 with their cutting edges along frame length 15 and aligned with front face 14. Resilient member 18 extends along vertical z axis and attaches blade frame 12 at the middle of length 15 to base 11. Alignment of a single resilient member 18 with z axis and its attachment to the middle of blade frame 12 and base 11 allows rotation of blade frame 12 around three x, y, and z axes relative to base 11.

As a multi-use device, blade cartridge 10 is removably attached at base end 13 to a handle through a latching mechanism (not shown). As a disposable device, blade cartridge 10 may be fixedly attached to a handle.

Resilient member 18 is made of a material such as rubber or plastic and may be molded as an integral part with base 11 and blade frame 12. Other modes of assembly are use of adhesive or insertion of resilient member 18 into holes provided inside base 11 and blade frame 12. Typical rubber dimensions for resilient member 18 are a diameter of 3 mm and a length of 6 mm.

Resilient member 18 may also be a straight metal spring wire or helical spring. In this case, the ends of the wire or spring are bent for fixed attachment to base 11 and blade frame 12. The helical spring preferably has one to three coils.

Resilient member 18 may have separate sections, each section providing deformation mainly relative to a separate axis. Each of these sections may have a wave or U shaped geometry to allow the required deformation.

The user holds the handle attached to cartridge 10, pushes blade frame 12 on the skin and slides it to shave the beard or hair. Any misalignment of blade frame 12 with the skin or imbalance in the forces at different points between blade frame 12 and the skin causes a rotational moment or torque which transfers to resilient member 18. Resilient member 18 flexes around x and y axes and twists around z axis relative to base 11 and the handle. The flexure and twist rotate blade frame 12 around x, y, and z axes and align it with the skin surface under blade frame 12. This also creates uniform pressure in the contact area between blade frame 12 and the skin.

Resilient member 18 naturally provides increasing resistance to rotation around any axis through flexure or torsion. However, stop members are provided on blade frame 12 or base 11 to limit the rotation of blade frame 12 and provide rigidity for full shaving force exertion after alignment.

Here, the rotation of blade frame 12 is limited by stop members 19 around x axis, by stop members 20 around y axis, and by stop members 21 around z axis.

The drawing in FIG. 1 is approximately drawn to scale for a typical razor wherein the length of blade frame 12 is 40 mm. The range of rotation of blade frame 12 around each axis is about 30 degrees. Depending on the design, stops have typical width and thickness of 2-3 mm and length of 4-8 mm.

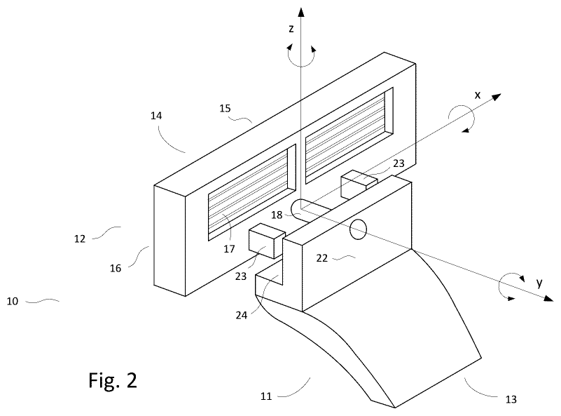

The second preferred embodiment of the invention, FIG. 2, is like the first preferred embodiment, but with the resilient member 18 aligned along horizontal y axis. In this configuration, resilient member 18 bends around x or z axes and twists around y axis.

Stops 23 limit the rotation of blade frame 12 around x axis and y axis when coming in contract with surface 24 of cartridge base 11.

Stops 23 also limit the rotation of the blade frame 12 around x axis when contacting wall 22 of cartridge base 11.

The distance between stops 23 as well as the distance between stops 23 and surface 24 and between stops 23 and wall 22 are determined to allow a rotation of about 30 degrees around each axis.

The drawing in FIG. 2 is approximately to scale for a typical razor wherein the length of blade frame 12 is 40 mm. The range of rotation of blade frame 12 around each axis is about 30 degrees. Depending on the design, stops have typical width and thickness of 2-3 mm and length of 4 mm.

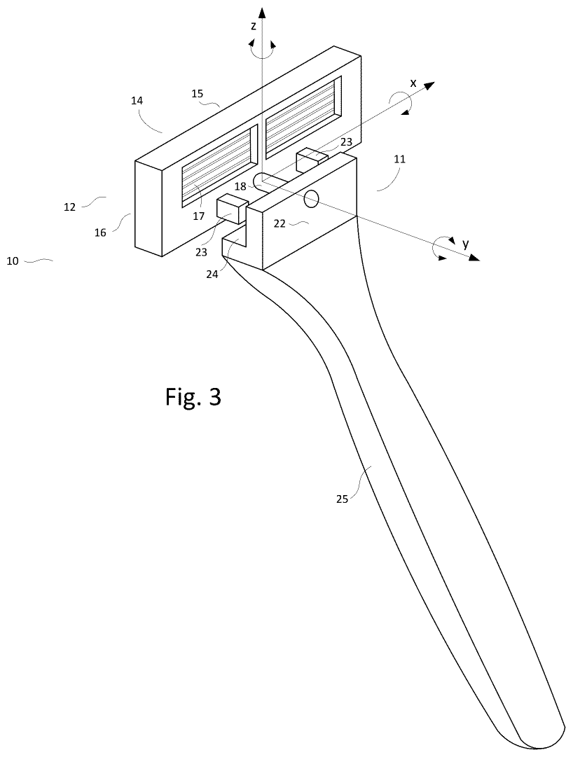

The third preferred embodiment, FIG. 3, is like the second preferred embodiment, but with a permanent handle 25 attached to base 11 or integrated with it.

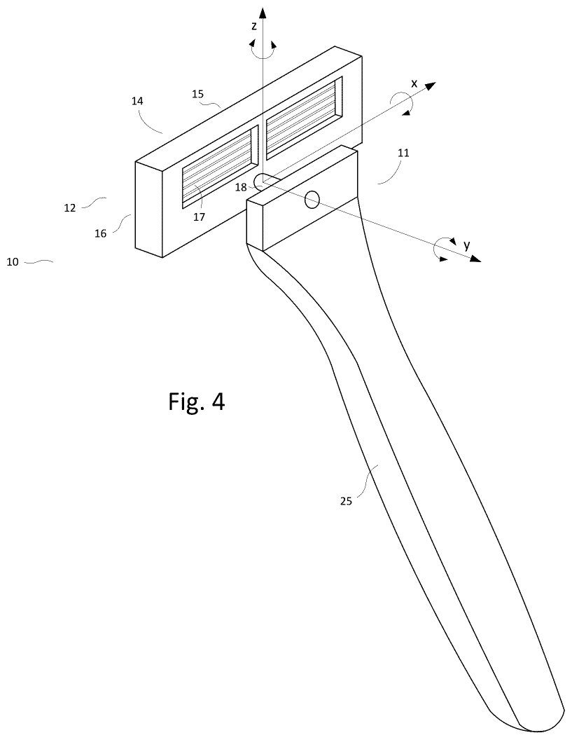

As mentioned earlier, resilient member 18 naturally provides increasing resistance to rotation around any axis through flexure or torsion. In all embodiments of the invention resilient member 18 dimensions and stiffness can be selected such that with a given deformation, it provides the required shaving force without any stop member. One such configuration is shown in FIG. 4 as the fourth embodiment of the invention.

The fourth preferred embodiment simplifies the razor system, while preventing excessive force by the user on the skin which eliminates any chance of skin cut, scratching, and irritation.

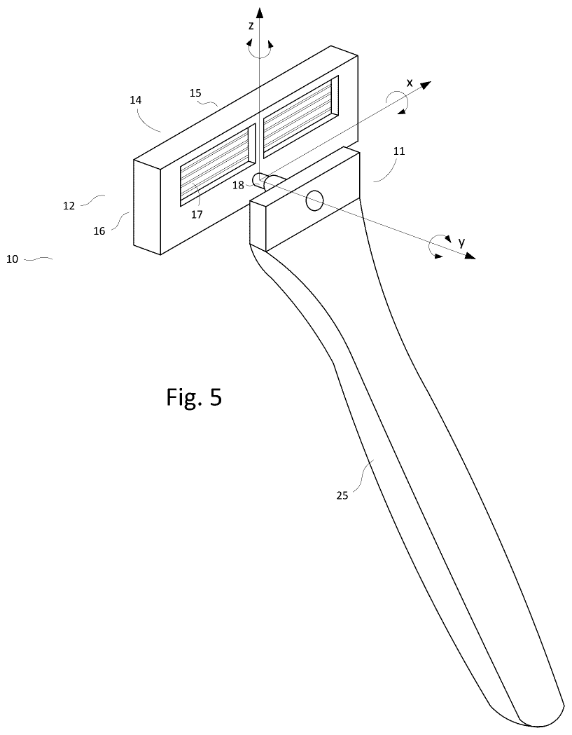

The fifth preferred embodiment of the invention, FIG. 5, is like the fourth preferred embodiment with some modification in resilient member 18. Here, resilient member 18 has a smaller diameter or stiffness along part of its length near the attachment end to blade frame 12 compared to the rest of its length. With this configuration, resilient member 18 readily deforms to allow alignment of blade frame 12 with the shaving area. Then, the stiffer or thicker part of resilient member 18 provides additional resistance to pivoting of blade frame 12 sufficient for the blades do the shaving without the need for rigid stops against blade frame 12.

Resilient member 18 in the fifth preferred embodiment has been shown with a stepped profile. It could also have a profile with continuously enlarging cross section.

The attachment locations of resilient member 18 to the blade frame 12 in the preferred embodiments are typical examples. The attachment location can be anywhere on the back or lower edge of blade frame 12, preferably symmetrically in relation to its left and right edges.

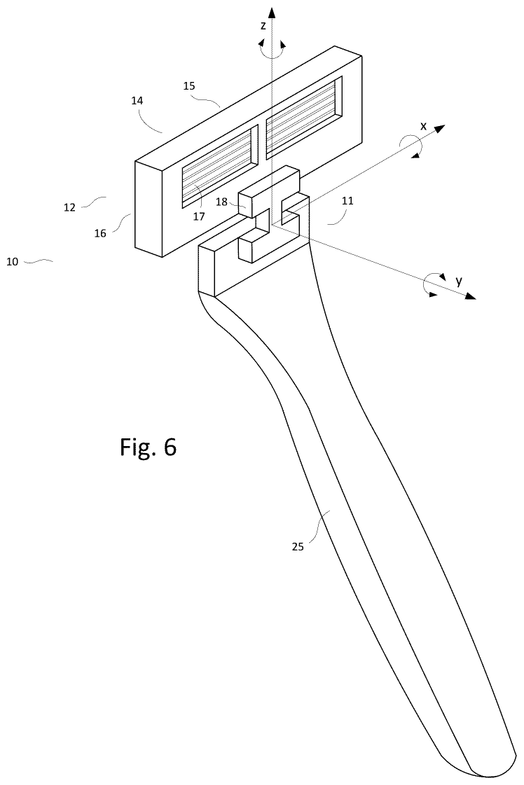

The sixth preferred embodiment, FIG. 6, shows another example of such attachment via molding or assembling with adhesive.

Resilient member 18 in the preferred embodiments is shown in its simplest form for the bending and twisting functionality of the invention, simplicity of manufacturing and clarity in teaching the invention. At one part of its length, it has a cross section suitable for the bending and twisting functionality of for purpose of the invention. The rest of its length may have cross sections larger than the pivoting or rotating functional section. Its attachment sites to blade frame 12 and base 11 may have larger cross sections compared to its mid length cross section.

Resilient member 18 may have a cross section to deform mainly around one axis. As an example, it may be a strip to bend and allow rotation of blade frame 12 around x axis only.

The twisting angle of resilient member 18 is proportional to the length of resilient member 18. By selecting a specific length for resilient member 18, a desired rotation for blade frame 12 around z axis may be designed independently of the bending properties of resilient member 18.

The stop shapes and locations in the preferred embodiments are typical examples. Other configurations for limiting the rotation of the blade frame 12 are part of the present invention.

Providing rotational flexibility around all axes is desirable to prevent excessive force and skin irritation due to misalignment of blades with the shaving area.

The invention in its general form is a razor having a razor blade securing member attached to a cartridge base or a handle via a single resilient member to allow rotation of the razor blade securing member at least around one axis.

I claim:

1. A razor cartridge for shaving face or body hair, comprising:
a base with a receiving end for attachment of the cartridge to a handle,
a razor blade frame having upper and lower sides defining its length, left and right sides defining its height, and an opening with a front face and a back face,
a plurality of razor blades installed inside the razor blade frame with cutting edges along the frame length and aligned with the front face,
a resilient member with a first end and a second end defining its length,
the first end of the resilient member is attached fixedly, equidistant from the left and right sides of the razor blade frame to the back or lower side of the razor blade frame or a projection therefrom,
the second end of the resilient member is fixedly attached to the cartridge base or a projection therefrom,
the razor blade frame can rotate through flexure or twisting of the resilient member around axes along the length, height, or perpendicular to the front face of the razor blade frame.

2. The razor cartridge of claim 1 wherein after an initial deformation of the resilient member and alignment of the razor blade frame with the area to be shaved, the resilient member provides sufficient force for the blades to cut through the hair and shave the area.

3. The razor cartridge of claim 1 wherein the resilient member has a variable cross section along its length.

4. The razor cartridge of claim 1 wherein the cartridge base or projections therefrom limit the rotation of the razor blade frame to a desired angle through contact with the back or lower side of the razor blade frame or projections therefrom.

5. The razor cartridge of claim 1 wherein the razor blade frame additionally has a member connecting the middle of its upper and lower sides, and the first end of the resilient member is attached to the said member or a projection therefrom.

6. The razor cartridge of claim 1 wherein the resilient member has a longitudinal axis parallel to the height of the razor blade frame.

7. The razor cartridge of claim 1 wherein the resilient member has a longitudinal axis transverse or perpendicular to the front face of the razor blade frame.

8. The razor cartridge of claim 1 wherein the resilient member has a cylindrical geometry.

9. The razor cartridge of claim 1 wherein the resilient member has a prismatic geometry.

10. The razor cartridge of claim 1 wherein the resilient member is made of rubber.

11. The razor cartridge of claim 1 wherein the resilient member is a helical spring.

12. The razor cartridge of claim 1 attached to a handle.

13. A razor for shaving face or body hair, comprising:
a longitude as handle having a top end,
a razor blade frame having upper and lower length sides, left and right height sides, and an opening with a front face and a back face,
a plurality of razor blades installed inside the razor blade frame with cutting edges along the frame length and aligned with the front face,
a resilient member with a first end and a second end defining its length,
the first end of the resilient member is attached fixedly, equidistant from the left and right sides of the razor blade frame to the back or lower side of the razor blade frame or a projection therefrom,
the second end of the resilient member is fixedly attached to the top end of the handle,
the razor blade frame can rotate through flexing or twisting of the resilient member around axes along the length, height, or perpendicular to the front face of the razor blade frame.

14. The razor of claim 13 wherein the top end of the handle, or projections therefrom limit the rotation of the razor blade frame to a desired angle through contact with the razor blade frame or projections therefrom.

15. The razor of claim 13 wherein the resilient member has a variable cross section along its length.

16. The razor cartridge of claim 13 wherein the resilient member material is metal.

17. The razor of claim 13 wherein the resilient member material is rubber.

18. The razor of claim 13 wherein the resilient member is a helical spring.

19. A razor handle for temporary or permanent attachment to a razor blade frame for shaving face or body hair, comprising:
An elongated handle having a longitudinal axis, an upper part, and a lower part along its axis,
the upper and lower parts are attached to each other via a resilient member along the axis,
the razor blade frame has a front face with an opening and a plurality of razor blades inside the opening with their edges aligned with the front face,
the razor blade frame is attached to the upper part of the handle with the blade edges perpendicular to the handle axis,
the razor blade frame can rotate through flexure or twisting of the resilient member around axes along the handle axis, the blade edges, or perpendicular to the razor blade frame face.

20. The razor handle of claim 19 wherein the degree of rotation of the razor blade frame is limited by the lower part of the handle or projections therefrom through contact with the upper part of the handle or projections therefrom.
